(19) United States
(12) Patent Application Publication
(10) Pub. No.: US 2017/0307474 A1
(43) Pub. Date: Oct. 26, 2017

(54) Method and Apparatus for Measuring the Local Birefringence along an Optical Waveguide

(71) Applicant: ECOLE POLYTECHNIQUE FEDERALE DE LAUSANNE (EPFL), Lausanne (CH)

(72) Inventors: Luc Thévenaz, Grandevent (CH); Miguel Gonzalez-Herraez, Alcalà (ES); Marcelo Alfonso Soto Hernandez, Lausanne (CH); Hugo Fidalgo Martins, Porto (PT); Xin Lu, Lausanne (CH)

(21) Appl. No.: 15/509,857

(22) PCT Filed: Sep. 17, 2015
(86) PCT No.: PCT/IB2015/057151

§ 371 Date: Mar. 9, 2017

(30) Foreign Application Priority Data
Sep. 17, 2014 (IB) PCT/IB2014/064598

(51) Int. Cl. G01M 11/00

(52) U.S. Cl. CPC G01M 11/3172; G01M 11/3181

(57) ABSTRACT

This invention relates to a system and method to determine the distributed birefringence profile along an optical fibre. Birefringence manifests as different refractive indices for two orthogonal states of polarization of the light propagating in the optical fibre. The technique is based on the correlation among sets of measurements acquired using phase-sensitive optical time-domain reflectometry (φOTDR), launching light into the fibre with multiple states of polarization. The correlation between the measurements performed while sweeping the laser frequency gives a resonance (correlation) peak at a frequency detuning that is proportional to the refractive index difference between the two orthogonal polarizations. This enables measurements of the local value of the phase birefringence at any position along the optical fibre, so that longitudinal fluctuations of its value can be evaluated. Such fluctuations can be induced either accidentally during cabling and installation processes, or voluntarily due to varying conditions or environmental quantities such as temperature, strain and pressure, or even unintentionally as a result of a badly controlled manufacturing process.

### CROSS-REFERENCE TO RELATED APPLICATIONS

This application claims the benefit of international patent application PCT/IB2014/064598 filed Sep. 17, 2014 the entire contents of which are incorporated herein by reference.

### FIELD OF THE INVENTION

This invention is related to the measurement of birefringence in optical waveguides and, in particular, in optical fibres. This invention has, for example, potential applications in the characterisation of optical fibres for telecommunication applications, and distributed optical fibre sensing, especially for, but not restricted to, pressure sensing.

### BACKGROUND OF THE INVENTION

Birefringence is an optical property that characterises any kind of optical fibre and manifests as a different effective refractive index for two orthogonal polarizations of the light propagating in the fibre.

It originates from any kind of factor that breaks the symmetry of the fibre core cross-section. Usually the birefringence is not constant along the entire fibre length as a result of non-uniformities in the fibre drawing process. Although longitudinal birefringence changes due to manufacturing process are typically small, these can be significantly affected by external environmental factors such as temperature, strain and pressure, as well as by bends and twists introduced during cabling and installation processes.

Birefringence limits the data rate capability of optical fibres for communications and therefore it must be kept as low as possible. Although currently manufactured single-mode fibres (SMF) show low levels of birefringence (e.g. Δn˜10⁻⁷), small random fluctuations in the core circularity along the fibre (and hence, in the fibre birefringence) can lead to undesired changes in the state of polarization of the propagating light. Actually, some short fibre sections can abnormally show large birefringence, being a crucial factor on scaling polarization-mode dispersion (PMD), which can significantly distort optical signals and limit the performance of high-speed optical communications systems, especially over long distances.

On the other hand, polarization-maintaining fibres (PMF) are characterised by larger levels of birefringence (e.g. ˜10⁻⁴), making them very attractive for many applications in telecommunications and optical fibre sensing. A high birefringence is a means to maintain a steady state of polarization of the light propagating along an optical fibre, well and constantly aligned. Thus, the uniformity of the fibre birefringence is an important parameter for design and system optimisation, and any variation in the birefringence normally leads to unwanted detrimental effects.

A technique to measure the distributed profile of local birefringence along an optical fibre is of great interest for fibre characterisation.

The fibre birefringence is also affected by external factors, such as temperature, strain and pressure; and therefore, the continuous monitoring of the fibre birefringence has interesting potential applications for distributed optical fibre sensing in order to detect environmental changes.

Actually, it has been demonstrated that some fibres, such as photonic crystal fibres (PCFs), are highly sensitive to hydrostatic pressure. This is observed in any fibre showing a structural transversal asymmetry that results in an anisotropic strain and/or deformation to a uniform radial strain applied to the fibre, such as realised under an applied hydrostatic pressure. Therefore, measuring the longitudinal birefringence profile of this kind of fibres can be an excellent tool to develop distributed pressure sensing.

There are many measurement techniques proposed for birefringence measurement; however, most of them only provide an evaluation of the average birefringence, and cannot be used to measure the local birefringence at each fibre position.

Methods for distributed birefringence measurements have been recently proposed; these are essentially based on optical frequency-domain reflectometry (OFDR), polarization-sensitive optical time-domain reflectometry (POTDR), polarization-sensitive optical frequency-domain reflectometry (POFDR), Brillouin optical time reflectometry (BOTDR) and dynamic Brillouin gratings (DBG).

From all these techniques, POTDR, POFDR and BOTDR are indirect measurement methods, in which the evolution of the state of polarization of the backscattered signal and respective beat length are measured and then used to calculate the local birefringence information based on given mathematical models. On the other hand, OFDR and DBG allow for more direct measurements of the local fibre birefringence. OFDR provides very high spatial resolutions but with the cost of a lengthy calculation process, covering only a limited fibre range. This feature limits significantly the possibilities to characterise long fibres, as typically employed in optical communication systems. DBG uses a complex system: the generation of the grating by stimulated Brillouin scattering actually uses three different high-power lightwaves at different wavelengths, requiring access to both fibre ends and a precise adjustment of frequency and polarization of the interacting waves.

While indirect measurement methods allow the characterization of low birefringence fibres, direct methods have only been used for birefringence measurements along high birefringence fibres, as polarization-maintaining fibres (PMFs), being very difficult (though not impossible) to use them for measuring low birefringence fibres, as SMFs.

Therefore, there is still the need in the state of the art of a method for direct and distributed birefringence measurement along optical waveguides, which can present high or low birefringence, over long sensing ranges, with high spatial resolution and which does not require high complexity or lengthy calculations. The present invention addresses the above mentioned inconveniences of known methods for distributed birefringence measurements.

### SUMMARY OF THE INVENTION

This invention concerns a system and method to determine a distributed birefringence profile along an optical waveguide, in particular, an optical fibre.

In particular, the present invention concerns a system according to claim 1 and a method according to claim 15. Further aspects and advantages of the present invention can be found in the dependent claims.

Birefringence manifests as different refractive indices for different polarization states, for example, two orthogonal states of polarization of the light propagating in the optical fibre.

The technique or method of the present invention is based on the correlation among sets of measurements acquired using phase-sensitive optical time-domain reflectometry (φOTDR), launching light into a fibre with multiple states of polarization.

The correlation between the measurements performed while sweeping the laser frequency gives a resonance (correlation) peak at a frequency detuning that is proportional to the refractive index difference between the two orthogonal polarizations.

This advantageously enables measurements of the local value of the phase birefringence at any position along an optical fibre, so that longitudinal fluctuations of its value can be evaluated.

Such fluctuations can be induced either accidentally during cabling and installation processes, or voluntarily due to varying conditions or environmental quantities such as temperature, strain and pressure, or even unintentionally as a result of a badly controlled manufacturing process.

In contrast to existing methods, the proposed method or technique allows the precise characterisation of the phase birefringence over very long optical fibres, including not only PMFs and PCFs (i.e. having a high birefringence) but also fibres that do not necessarily maintain the polarization (i.e. showing low birefringence), such as standard single-mode fibres (SMFs), dispersion shifted fibres (DSFs), or dispersion compensating fibres (DCFs), among others.

### DESCRIPTION OF THE DRAWINGS

The above object, features and other advantages of the present invention will be best understood from the following detailed description in conjunction with the accompanying drawings, in which:

FIG. 1 shows a general schematic of a basic embodiment of the present invention used to measure the Rayleigh backscattered signal in the time domain using optical pulses with controllable frequency and polarization;

FIG. 2 shows a first embodiment of the present invention, used to consecutively measure temporal traces with orthogonal polarization;

FIG. 3 shows a second embodiment of the present invention, used to simultaneously measure temporal traces with orthogonal polarization, where in this case a depolarised pulse is launched into the fibre;

FIG. 4 illustrates possible implementations to depolarise light, where FIG. 4(a) illustrates a scheme using an unbalanced Mach-Zenhder interferometer, and FIG. 4(b) illustrates a scheme using a polarization-maintaining mirror and a Faraday mirror;

FIG. 5 illustrates a third embodiment of the present invention, used to simultaneously measure temporal traces with orthogonal polarization, in this case a depolarised pulse composed of different optical frequencies is launched into the fibre;

FIG. 6 shows an exemplary experimental setup according to the present invention used to validate the invention, using the first (basic) embodiment;

FIGS. 7(a) and (b) show a distributed profile of phase birefringence versus distance along (a) a 80 m Panda PM fibre and (b) a 100 m elliptical-core PM fibre, where the measurements are based on the first (basic) embodiment;

FIG. 8 shows a distributed profile of phase birefringence versus distance along a 3 km-long SMF, the measurements being based on the embodiment optimised for low birefringence fibres;

FIG. 9 shows a local cross-correlation spectrum at a distance of 220 m for the measurement of a 3 km-long SMF, the measurements being based on the embodiment optimised for low birefringence fibres; the spectral width of the correlation peaks defines the minimum possible detectable birefringence with the method;

FIG. 10 shows a distributed profile of phase birefringence versus distance along an approximately 1.8 km-long Single mode fiber (SMF), where FIGS. 10(a) and 10(b) compare the spectrum obtained by the cross-correlation of consecutive measurements at orthogonal polarization in the basic system implementation of FIG. 2 with the one obtained by auto-correlating a single measurement in the improved system configuration of FIG. 3;

FIG. 11 shows the principle of a technique according to the present invention to measure the distributed profile of the phase birefringence of an optical waveguide, in which, the cross-correlation of two local φOTDR spectra, measured with orthogonal states of polarization, shows a correlation peak at a frequency shift Δν proportional to the local phase birefringence Δn; and

FIG. 12 shows another exemplary embodiment of the present invention, in which, the Rayleigh backscattering is split into two orthogonally-polarised signals that are simultaneously measured by two photo-detectors, originating two sets of time-domain measurements (φOTDR traces) that are then cross-correlated to obtain a correlation peak at a frequency shift Av proportional to the local phase birefringence Δn.

### DETAILED DESCRIPTION OF THE INVENTION

The present invention provides a new method and apparatus (system) to measure or determine the local birefringence of an optical waveguide, for example, an optical fibre at any longitudinal position.

The method or technique is based on the correlation of phase-sensitive optical time-domain reflectometry (φOTDR) measurements at two orthogonal states of polarization.

As mentioned above, in contrast to existing methods, the proposed method or technique allows the precise characterisation of the phase birefringence over very long optical fibres, including not only PMFs and PCFs (i.e. having a high birefringence) but also fibres that do not necessarily maintain the polarization (i.e. showing low birefringence), such as standard single-mode fibres (SMFs), dispersion shifted fibres (DSFs), or dispersion compensating fibres (DCFs), among others.

The minimum detectable birefringence is essentially given by the spatial resolution, which defines the spectral width of the cross-correlation peak. In this way, a minimum detectable birefringence of the order of 10⁻⁷ can be measured for spatial resolutions in the metre range, allowing the characterisation of single-mode fibres. The measured local birefringence along the optical fibre can also be used to detect distributed variations of environmental quantities, resulting in an excellent tool to realise, for instance, distributed pressure sensing.

### General Concepts

### Working Principle of the Conventional φOTDR Method (State-of-the-Art)

Conventional φOTDR is an accurate and efficient method to measure refractive index variations along an optical fibre. The method is based on the so-called Rayleigh scattering, which originates in optical fibres from non-propagating density fluctuations in the medium. Rayleigh scattering is an elastic process that induces no frequency shift on the backscattered light.

In the φOTDR technique, highly-coherent optical pulses are launched along the sensing fibre and the Rayleigh backscattering intensity is measured as function of the distance. Measured time-domain traces show the backscattered light intensity as a function of the distance, i.e. from the different scattering points. Traces show noise-like shaped pattern that originates from the random interference of the coherent Rayleigh light that is backscattered from frozen scattering centres present along an optical fibre.

Although traces show a random shape, this pattern is static and reproducible for a particular fibre if the refractive index, scattering centre size and optical frequency of the interrogating pulse do not change.

If the refractive index of a given fibre section changes between two consecutive measurements, the time-domain pattern will also change; however the original pattern in the fibre section can be perfectly retrieved by simply changing the light frequency, which can equivalently compensate the effect of the refractive index change. The required frequency detuning turns out to be fully proportional to the change in refractive index.

The measurement procedure requires Rayleigh intensity traces to be acquired using different laser frequencies ν, i.e. scanning the light frequency within a given frequency range, so that traces measured at a given time t can be denoted as Rₜ(z,ν).

The procedure also needs the use of a reference measurement Rᵣ(z, ν), which is then cross-correlated in frequency with consecutive Rayleigh measurements Rₜ(z, ν) at time t. The cross-correlation Xcorr(z₀, Δν)=Rₜ(z₀, ν)*Rᵣ(z₀,ν) gives the information of the frequency shift Δν induced by changes in the refractive index in the local Rayleigh reflected spectrum (at a given position z₀).

In other words, the procedure results in a spectrum showing a correlation peak at a frequency shift Δν which is proportional to the refractive index change. This way, considering that the refractive index depends on external environmental conditions such as temperature and strain, φOTDR systems offer the possibility to perform reliable distributed sensing along many kilometres of optical fibre.

### Modifications to the φOTDR Method According to the Present Invention

Compared to the known φOTDR technique, where the polarization state of the interrogating pulse is not a relevant parameter, the present invention described herein is based on the correlation obtained between spectral measurements performed with multiple states of polarization.

To facilitate comprehension, the description of the present invention herein will be presented based on the acquisition of two orthogonal states of polarization and on the cross-correlation between both measurements. However many other possibilities could be envisaged, including: autocorrelation of traces obtained with depolarized input, cross-correlation of two states acquired with orthogonal states, etc.

The method of the present invention requires launching an optical pulse, at a given polarization and optical frequency, into for example an optical fibre under test. The coherent Rayleigh backscattered light is detected in the optical receiver and acquired with an acquisition system that converts the electrical signal at the output of the photo-receiver into digital data in the computer. This detected signal is called phase-OTDR trace.

The process is, for example, repeated maintaining the same polarization, but changing the optical frequency of the pulse. This means that the coherent Rayleigh backscattered light is measured for each independent scanned frequency. This gives rise, for example, to a matrix Rₛ(z₀, ν) containing the phase-OTDR traces measured at different frequencies (see on the top-left side of the FIG. 11).

Then, for example, the process is repeated but using an orthogonal polarization. A new matrix R_{f}(z₀, ν) is generated (see on the bottom-left side of the FIG. 11). The scanned frequencies are in general the same, covering a given spectral range; however, some implementations may require scanning different frequency values.

These two measurements are compared performing a spectral cross-correlation. This means that for the two spectra (one for each polarization) measured at a given distance z₀ (see the example in the FIG. 11, where two similar but spectrally shifted traces are compared), are cross-correlated.

This process is repeated for all measured positions along the fibre (this means for each distance value). The cross correlation at a position z₀ gives rise to a correlation peak whose frequency is proportional to the local birefringence of the fibre at that position z₀.

Then the peak frequency of this correlation peak is retrieved by a given algorithm, for example, using a quadratic fitting. This fitting is repeated at each fibre location to retrieve a distributed profile of the correlation peak frequency versus distance.

In the case where depolarized light is used (as discussed in more detail later), the method according to the present invention comprises launching a depolarized pulse into the fibre and measuring the coherent Rayleigh backscattered light. The process is for example repeated for different scanned frequencies, generating for example a matrix with the data in frequency and distance domains.

Here, instead of performing the cross-correlation between two different spectra at position z₀, only one spectrum is measured at z₀. This spectrum contains the information from both birefringence axes of the fibre. The correlation peak is here obtained by the auto-correlation of that measured spectrum.

This process is repeated for all measured positions along the fibre (this means for each distance value z₀). The auto-correlation at a position z₀ gives rise to a correlation peak whose frequency is proportional to the local birefringence of the fibre at that position z₀. Then the peak frequency is retrieved as for instance by a quadratic fitting algorithm.

Let us denote these two measurements as Rₛ(z, ν) and R_{f}(z, ν) for, for example, the sets of acquisitions at the slow and fast axis, respectively. Since the fibre birefringence imposes a refractive index difference Δn between these two sets of measurements, the cross-correlation Xcorr(z₀, Δν)=Rₛ(z₀, ν)*R_{f}(z₀, ν), at a given fibre location z₀, shows a spectral peak at a frequency shift Δν=ν_{f}−νₛ proportional to the fibre phase birefringence Δn=nₛ−n_{f}, where νₛ, ν_{f} and nₛ, n_{f} are the frequencies and refractive indexes at the two orthogonal polarization axes (slow and fast axes). The procedure here requires obtaining the peak frequency Δν of the resonance peak. This can be obtained by for instance quadratic fitting algorithm.

Once the frequency shift profile Δν(z) along the fibre is obtained, the fibre birefringence profile Δn(z) can be straightforwardly obtained as Δn(z)=−n_{f}^{g}/ν_{f}·Δν(z), where n_{f}^{g} is the group refractive index of the fast axis.

In some cases, the data processing can use Δn to take into account the fact that the pulses propagating in the slow/fast axis travel at different velocities. This generally has a relatively small effect. It could nevertheless lead to some errors when very long fibres are measured. For instance, in a conventional PMF of Δn≈10⁻⁴, pulses are expected to be desynchronised by about 1 m after a propagation length of 10 km. An algorithm can optionally also be included in the data processing to correct or avoid possible errors resulting from this effect.

In the case of measuring fibres with high birefringence (e.g. PMFs or PCFs), the polarization state of the interrogating pulse can be alternately adjusted to match either of the two orthogonal polarization axes of the fibre. This can be implemented using a polarization switch or any other component (or set of components) that allows having or producing lightwaves or optical pulses with orthogonal polarizations.

Although the perfect alignment between the polarization of the pulses and one of the axes of the fibre is not essential for the invention, a substantially good alignment is preferable to maximise the amplitude of the correlation peak found at each position along the fibre. The essential point or aspect of the invention is to perform measurements by launching light into the fibre with different states of polarization. This is the key point of the invention.

As herein described, one exemplary simple implementation of the present invention is achieved by using measurements obtained with two orthogonal states of polarization. The only effect of having light in the two orthogonal polarization axes, as a result of an imperfect alignment, is the presence of an additional correlation peak at zero-frequency (so-called zero-shift peak), similar to the peak obtained in conventional φOTDR systems, while the amplitude of the correlation peak at Δν related to the local birefringence at Δn turns out to be reduced. The amplitude of the correlation peaks at zero-frequency and at Δν will depend on the ratio of light coupled in each of the axes.

For instance if light polarised with an angle of 45° (with respect to the fibre axes) is launched into a fibre, measuring the Rayleigh backscattered light with pulses at two orthogonal states of polarization leads to traces having practically the same information, i.e. highly correlated, leading to a strong correlation peak at zero-frequency, while the amplitude of the peak at Δν turns out to be reduced.

It is possible to acquire a single measurement, while launching light polarised with an angle of 45° with respect to the fibre axes, so that both polarization axes are simultaneously excited, and thus enabling the birefringence information to be retrieved from the auto-correlation of a single measured spectrum at each position.

Sometimes changes in the light polarization inside the fibre may lead to local polarization states perfectly aligned to one the fibre axes, and therefore the measurement will contain information of a single polarization axis at that given location, leading to an auto-correlation spectrum showing only the peak at zero frequency, whilst the peak related to the local birefringence at Δν could not be retrieved.

In such a situation, a longitudinal analysis of the correlation peak at Δν is expected to show amplitude fadings as a function of the distance, whose unpredictable fibre locations can be associated to positions where the polarization of the light is perfectly aligned to one the fibre polarization axes. Thus, the independent measurements carried out launching pulses at orthogonal polarizations turns out to be important to eliminate fadings along the fibre length, while being strictly non-essential for obtaining the information.

These amplitude fadings become even more evident and relevant in low birefringence fibres (e.g. SMFs), in which there are no constantly defined birefringence axes.

In this case the polarization of the pulses randomly changes inside the fibre and, in general, is never aligned to any particular axis. This way, the correlation peak containing information about the birefringence is expected to change randomly and alternately between Δν and −Δν. Note that, the zero-shift correlation peak appears when the two correlated measurements contain information from the two axes of polarization of the fibre, as occurs in SMFs. Consequently, measuring low birefringence fibres leads to a cross-correlation spectrum showing three peaks, one at zero frequency (the zero-shift peak), and two others symmetrically placed at ±Δν. The local amplitude of these peaks depends on the ratio of light coupled into the slow/fast axis at each fibre location. In order to avoid the misbalance between the amplitudes of the cross-correlation peaks at ±Δν and eventual amplitude fadings when one of the peaks is analysed as a function of distance, an optimised configuration should be implemented, as it will be later described in the following sections.

Note that the obtained zero-shift correlation peak is actually the same as the one obtained in the standard φOTDR system, and therefore provides information about fibre temperature and strain variations during the acquisition time, as well as about the averaged laser frequency drift.

If any of these factors changes during the acquisition of the two states of polarization, the correlation peaks at ±Δν containing the birefringence information will drift together with the zero-shift correlation peak, introducing an offset in the frequency measurements.

Measuring the peak at zero-frequency provides a reliable method to evaluate the stability of the system and to compensate undesired cross-sensitivities. However, the detrimental effects given by temperature changes and laser frequency drift can be avoided using a more advanced scheme, in which traces from the two orthogonal polarizations are simultaneously acquired. This way the cross-correlation peak will contain only information related to the local birefringence of the fibre, avoiding any potential shift of the correlation peaks. Different exemplary embodiments of the present invention will be described in further detail, including basic and more advanced implementations (embodiments).

### BASIC EMBODIMENT OF THE INVENTION

In a basic implementation of the present invention, the invention only requires a configuration similar to a standard φOTDR, with an additional control of the polarization of the pulses launched into the fibre.

A general schematic of the system or apparatus 1 of this embodiment is shown in FIG. 1.

The implementation basically requires means 3 for the generation of an optical pulse having controllable optical frequency (wavelength) and polarization. Pulses with multiple polarizations are launched into the fibre 5 (fibre under test (FUT)) and the backscattered Rayleigh signal is acquired in the time domain as a function of the frequency shift of the laser pulses by the receiver 7. The backscattered Rayleigh signal is directed to the receiver 7 by an optical component 9 that redirects the back scattered optical signal. The acquired backscattered Rayleigh signal is provided to a computer or processor 10 for processing.

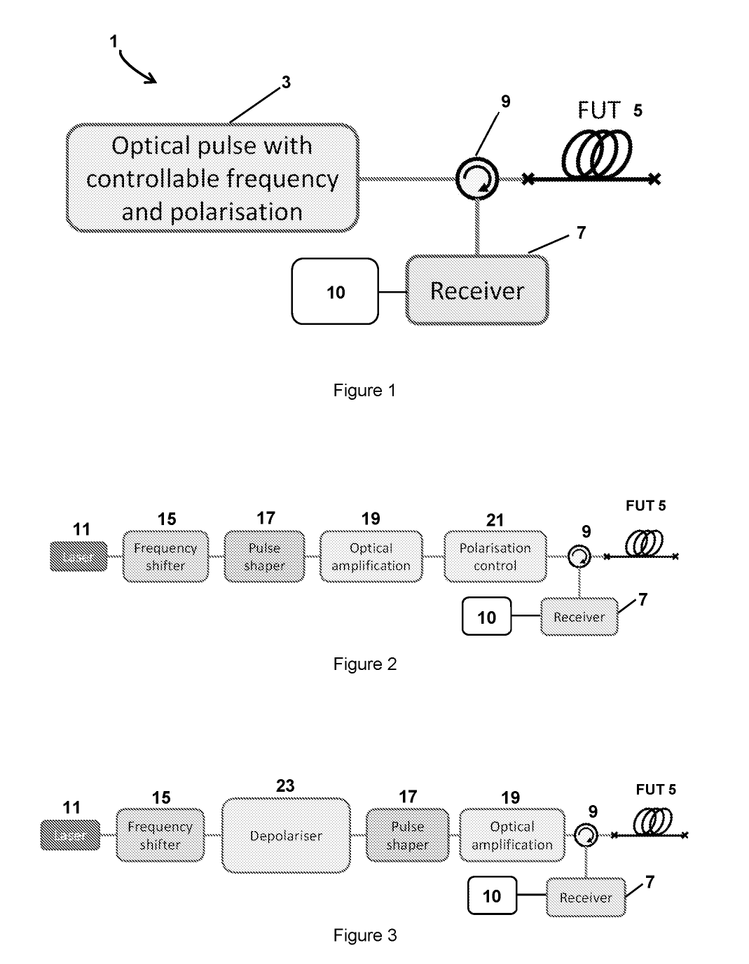

More specifically, the means 3 for pulse generation and control of the optical frequency and polarization described in FIG. 1 can be implemented using multiple blocks or elements, as exemplified in the exemplary system or apparatus 1 presented in FIG. 2.

The system or apparatus 1 includes an optical source 11, such as a laser source (for example, a continuous-wave source), followed by a frequency shifter 15 or element that permits to shift (change) and to scan the light frequency of the optical signal within a given optical frequency range.

Then, the system 1 further includes a pulse shaper 17 (for example, for temporal pulse shaping) or module for pulse shaping of the optical signal and for generation of an optical pulse, followed by an optical amplifier 19 or amplification block to boost or amplify the optical power of the optical signal launched into the fibre 5 up to a determined optimal level.

While a continuous-wave source 11 and a pulse shaper 17 are preferably used to produce an optical pulse, it is also possible to use a pulsed optical source in certain cases.

There is no real preference in positioning of the elements 15, 17 providing the frequency scanning and the pulse shaping, so that they can also be placed in the opposite order (with respect to FIG. 2).

Before launching the optical pulses into the fibre 5, a precise adjustment of the polarization is required. Thus, the system 1 includes a specific element that is a polarization controller 21 to switch the polarization of the pulse(s) for example between two orthogonal polarization states and, in the case of measurements carried out on high-birefringence fibres, to also align the polarization of the light with the fibre axes.

Pulses are injected into the fibre 5 under test (FUT) through optical component 9, for example, an optical circulator or any other component offering the same functionality, as for instance an optical coupler. The Rayleigh backscattered light is sent or directed to the receiver 7 by the optical component 9. The receiver 7 can be the same as that in a standard φOTDR, and essentially includes a single photo-detector. However, in some cases an amplifier for optical amplification (together with a filter for suitable filtering) can also be included in front of the photo-detector.

The computer 10 is connected to the receiver 7 and configured to receive the Rayleigh backscattered signal from the receiver 7. The computer 10 is configured, for example via the inclusion of an algorithm in a memory, to calculate a correlation value for a given location z₀ along the fibre 5 from the acquired Rayleigh backscattered intensity signal provided by optical pulses with different polarization states propagating through the fibre 5.

As mentioned above, the computer 10 is configured to calculate a cross-correlation value for the acquired Rayleigh backscattered intensity signals according to the equation Xcorr(z₀, Δν)=Rₓ(z₀, ν)*R_{y}(x₀, ν) for a given location z₀ along the fibre 5 to determine a spectral peak at an optical frequency shift Δν=ν_{y}−νₓ proportional to the fibre birefringence profile value Δn=nₓ−n_{y}, where νₓ, ν_{y} are the optical frequencies of the optical pulse at a first polarization state and a second polarization state respectively. The first and second polarization states are different polarization states and nₓ, n_{y} are the refractive indexes values at the first and second polarization states.

In the case where the first and second polarization states are two (substantially) orthogonal polarization states, the computer 10 is configured to calculate a cross-correlation value for the acquired Rayleigh backscattered intensity signals according to the equation Xcorr(z₀, Δν)=Rₛ(z₀, ν)*R_{f}(z₀, ν) for a given location z₀ along the fibre 5 to determine a spectral peak at an optical frequency shift Δν=ν_{f}−νₛ proportional to an optical waveguide birefringence profile value Δn=nₛ−n_{f}, where νₛ, ν_{f} and n_{f}, nₛ are the frequencies and refractive indexes at the two orthogonal polarization axes (for example, slow and fast axes).

The computer is, for example, configured to calculate the correlation between at least two Rayleigh backscattered intensity signals obtained while sweeping the optical frequency of the optical pulses through an optical frequency range to provide a resonance or correlation peak at a frequency detuning that is proportional to the refractive index difference between the first and second (for example, orthogonal) polarization states.

The measurement procedure or method comprises the consecutive acquisition of Rayleigh backscattered intensity traces or signals as a function of time at two orthogonal polarizations of the generated optical pulses.

After performing a standard set of φOTDR measurements at a given polarization, a second set of Rayleigh backscattered intensity traces as a function of time is acquired using pulses with orthogonal polarization. Both measurements should have preferably, but not necessarily, the same number of spectral points, i.e. the same number of scanned frequencies.

Considering that the measurement time with φOTDR can be of the order of a few seconds, temperature drifts and laser frequency fluctuations during the acquisition time could be expected to induce typical frequency errors of a few tens of MHz. This could significantly impact on the accuracy of birefringence measurements, especially for low birefringence fibres showing typically frequency shifts Δν of the order of only a few tens of MHz. Under such a situation, the zero-shift correlation peak could be used to compensate undesired cross-sensitivities, providing a reliable method to evaluate the stability of the system.

In the case of measuring the birefringence of PMFs, a typical frequency error of a few tens of MHz could represent an error lower than 1% of the absolute measured frequency (being of the order of tens of GHz). For some kinds of applications this low level of error can be tolerated, and therefore, the detection of the zero-frequency peak is not required. However, in the case of measuring low birefringence fibres, the frequency fluctuations are expected to be of the same order of magnitude than the frequency of the correlation peaks at ±Δν. Therefore, a correction method is preferably considered to provide reliable measurements. For instance, a frequency-stabilised optical source can be included in the system; however, this will not be enough for a proper correction if the fibre temperature is expected to drifts, even by a few mK (milliKelvin).

The scanned frequencies are typically, but not necessarily, the same for the two measurements with two orthogonal polarizations (i.e. the same central frequency and scanning range). This is essentially the case when measuring low birefringence fibres, in which the frequency scanning range can be limited to a few hundreds MHz or a few GHz, depending on the expected frequency shift Δν associated to the birefringence Δn.

On the other hand, in the case of measuring fibres with high birefringence, the scanning range of the two measurements must be in principle much larger than in the case of low birefringence fibres, covering a range of several tens of GHz. However, this broad scanning range can actually be avoided if the average birefringence Δn̅ and the associated frequency shift Δν̅ are approximately known. In such a case it is possible to scan a narrower frequency range for the two sets of measurements; with a frequency separation equal to the expected average frequency Δν̅. The required acquisition procedure is the same as the previously described one, however, the data processing should take into account the frequency difference Δν̅ between the two scanned ranges.

For instance if the expected average frequency shift associated to the average birefringence is Δν̅=40 GHz, then traces at the two polarizations can be acquired by scanning over a frequency range of some hundreds MHz or a few GHz, separated by 40 GHz. If under this condition, the cross-correlation spectrum shows a peak at Δν′=500 MHz at a given position z₀, then the real frequency Δν associated to the birefringence Δn at that fibre location has to be calculated as Δν(z₀)=Δν̅+Δν′(z₀)=40.5 GHz.

This principle can also be used to increase the efficiency of the measurement if a large frequency range is required to be scanned. For instance, in order to scan a frequency range of 0-99 GHz, it is possible to perform 10 frequency scans of 1 GHz range in one axis ([ν, ν+1] GHz; [ν+1, ν+2] GHz, . . . , [ν+9, ν+10] GHz) and 10 frequency scans of 1 GHz range in the other axis ([ν+9, ν+10] GHz; [ν+19, ν+20] GHz; . . . ; [ν+99, ν+100] GHz;).

By correlating all the frequency scans of one axis with those of the other axis, the result will be equivalent to scan a frequency range of 0-99 GHz, but requiring only 20 frequency scans with steps of 1 GHz. This procedure advantageously improves the efficiency of the acquisition procedure, resulting in a significant reduction of the measurement time.

### Embodiment of the Invention for Improved Low Birefringence Measurements

As mentioned above, temperature drifts and laser frequency fluctuations highly impact the accuracy of the measured birefringence, especially when fibres with low birefringence are characterised. Note that the origin of these errors is because the two measurements are acquired consecutively, which may result in different measurement conditions if the temperature and laser frequency change in between the 2 sets of measurements. Although the use of the zero-shift correlation peak can be used for correcting this effect, the above-mentioned errors can be completely avoided, for example, if the two measurements at orthogonal polarizations are simultaneously acquired.

FIG. 3 shows an implementation of the present invention using depolarized light that is injected into the fibre 5. The exemplary implementation illustrated in FIG. 3 is in particular for the case of measuring low birefringence fibres.

In this case a depolarised pulse having a single optical frequency (single optical carrier) is launched into the fibre 5.

The main difference with respect to the system 1 of the previous embodiment of FIG. 2 is that in this case an additional element that is a depolariser 23 is included to generate depolarised light at a single optical frequency.

The depolariser 23 is configured to generate a single-frequency optical signal with a random state of polarization that is then used by pulse shaper 17 to generate an optical pulse having a single optical frequency (single optical carrier) for injection into the fiber 5.

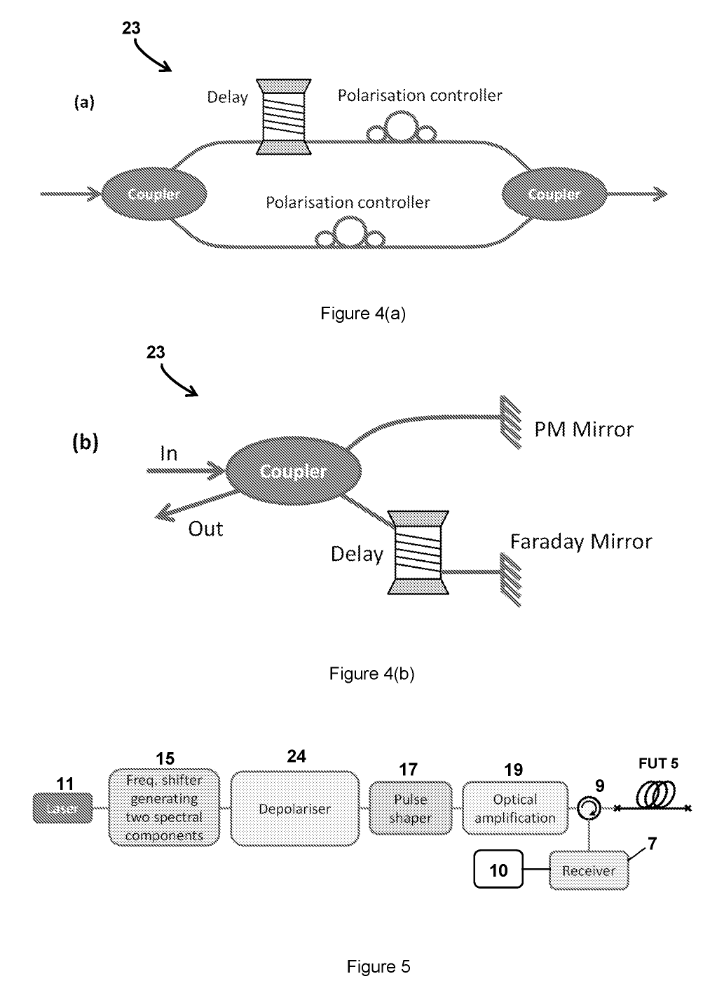

More details of the depolariser 23 to generate depolarised light are described below with reference to FIG. 4.

After generating depolarised light, a pulse can be shaped or generated by a single pulse shaping module or pulse shaper 17. This results in a depolarised pulse having a single optical frequency that is launched into the FUT 5.

Although the generation of depolarised light can be applied to the laser continuous-wave light, instead the generation of depolarised light is possible after generating or shaping the optical pulses, this nevertheless would require a more complex system.

Here the frequency shifter 15 allowing the scan is shown in the above embodiments at the output of the optical source 11, but this position is not required to be strictly there; the frequency shifter 15 can actually be placed at any location before the launching of the pulses into the fibre 5.

An exemplary embodiment for generating depolarized light for injection into the fibre 5 is now described. This exemplary embodiment provides depolarized light by using two simultaneous incoherent pulses with orthogonal polarizations.

In this case two phase-decorrelated (incoherent) pulses showing orthogonal polarizations and having the same optical frequency are launched synchronously or simultaneously into the fibre 5.

The main difference with respect to the system 1 of the previous embodiment of FIG. 2 is that in this case the additional element of the depolariser 23 is configured to generate or produce substantially simultaneously two incoherent lightwaves or optical pulses at the same frequency but with orthogonal polarization. More details of the depolariser 23 to generate light in two orthogonal polarizations are described below with reference to FIG. 4.

After generating both orthogonally-polarised signals, a pulse is shaped or generated by a single pulse shaping module or pulse shaper 17. This results in two pulses having orthogonal states of polarization and being perfectly aligned in time (depolarised light pulse) at the input of the FUT 5.

Whilst the orthogonal polarizations ensure the excitation of both axes of the fibre 5, the incoherence of the light ensures the non-interfering propagation of the two pulses along the fibre 5. If pulses are coherently launched into the fibre 5, this simply results in a change of the pulse polarization, being equivalent to use a single pulse with the resulting state of polarization. Note that although both pulses launched into the fibre might also have different frequencies, this would require that the module for frequency scan 15 generates two spectral components instead of one; however, such a configuration is preferably avoided when measuring low birefringence since the required frequency difference is usually small and results in a more complex system.

A possible implementation of a depolariser 23 is to generate depolarised light is to split the optical signal into two branches and rotate the state of polarization of one of them by 90° with respect to the other branch. This approach is illustrated in FIG. 4, which shows two possible implementations. These two implementations require also the use of a delay line to decorrelate the two orthogonally-polarised optical signals, and then the incoherent re-combination of the two waves.

Concerning depolariser 23, FIG. 4(a) shows a possible implementation to generate two optical signals with orthogonal polarizations. In this case the incoming light is split, for example by a coupler, into two branches: one of them rotates the polarization of the light by 90° with respect to the other branch.

Additionally, a delaying element (given by an optical delay line, or simply by a long optical fibre) has to be placed in one of the branches, chosen to cause a delay longer than the coherence time of the optical source. FIG. 4(a) is a scheme using an unbalanced Mach-Zenhder interferometer.

Another possibility is depicted in FIG. 4(b), showing a scheme using a polarization-maintaining mirror and a Faraday mirror, where the incoming light is divided into two by a polarization-maintaining coupler having four ports: a fraction of the light is reflected by a polarization-maintaining mirror, while the other fraction is reflected by a Faraday mirror, which rotates the polarization in 90°. A delaying element is also included and it can be placed in any of the two branches. The orthogonally-polarised lightwaves reflected from the mirrors are combined and exit through the fourth port of the coupler.

Alternatively, the depolariser 23 may consist of or comprise a polarization scrambler.

Using the above-described configuration of FIG. 3, the light reaching the detector of the receiver 7 contains a linear incoherent superposition of the traces for the two orthogonal polarizations. This means that a single measurement is sufficient to get all information from the Rayleigh backscattered light in both polarizations.

Thus, the local birefringence along the fibre 5 can be retrieved from the auto-correlation of the measured spectrum at each fibre location.

The computer 10 in this embodiment is configured to calculate an auto-correlation spectrum from the acquired Rayleigh backscattered intensity signal containing a superposition of Rayleigh backscattered intensity signals produced by (the depolarised light pulse) the pulses of first and second polarization states in order to determine the birefringence profile along the fibre 5.

As mentioned before, the resulting auto-correlation spectrum shows three correlation peaks, one at zero frequency and two peaks at ±Δν. The birefringence profile along the fibre can be retrieved from any of the two peaks at ±Δν.

### Embodiment of the Invention for Improved High Birefringence Measurements

In the case of measuring high birefringence fibres, a similar concept as in the previous section relating to depolarised light can be used; i.e. the Rayleigh backscattered light from a depolarised light pulse or two orthogonal states of polarization can be simultaneously measured.

The main difference with the previous embodiment illustrated in FIG. 3 is that in this case the depolarised light pulse or the two pulses launched simultaneously into the fibre 5 can have very different optical frequencies (of the order of the expected Δν̅). Although the scheme can also be implemented with pulses of the same frequency, this results in an inefficient system, requiring much longer measurement times since a broad spectral range covering many tens of GHz has to be scanned by steps of a few MHz. Moreover most of the measured traces would contain no relevant information for the proper detection of the correlation peak at Δν.

FIG. 5 shows another possible implementation/embodiment of the present invention. The system 1 is essentially the same as that described in the previous section (see FIG. 3). The only difference is that in this case pulses with two distinct optical frequencies are generated. This can be achieved, for example, by the frequency shifter 15 simultaneously to the frequency scan, by using a simple amplitude modulator in carrier-suppression mode which generates two sidebands separated by a frequency difference of a few tens of GHz, depending on the expected average correlation peak frequency Δν̅.̅The same modulator can perform the required frequency scanning just by changing the frequency of the modulating electrical signal. Then, the two generated frequency components can be spectrally separated by proper optical filtering, using for example an optical filter, into two different branches.

The polarization state of the light in one of these branches can be rotated, for example, by 90° (in device 24 for producing depolarised lightwaves having different optical frequencies) to produce depolarised signals that will be shaped into a pulse in the pulse shaper 17 and launched into the fibre 5.

Depolarizer 24 acts on an input light signal containing more than 1 frequency component (for example, 2 frequencies). After the pulse shaper 17, a single pulse that contains multiple optical frequencies is provided for input into the fiber 5. Another alternative option is to use two independent lasers, while the light frequency difference is precisely stabilised. The polarization of one of the spectral components has to be rotated in or by 90° with respect to the other one (for example, via a device 24).

Device 24 can be implemented identically to device 23, but there are other possible implementations to rotate the polarization of some frequency components. For example, a differential group delay (DGD) element can be used.

Due to the frequency difference of the light in the two branches and due to the eventual use of two independent lasers, the delay in one of branches is not always required. This ensures that pulses launched into the fibre 5 have orthogonal polarizations and different frequencies.

### Embodiment of the Invention for Simultaneous Detection of Two Orthogonally-Polarised φOTDR Traces

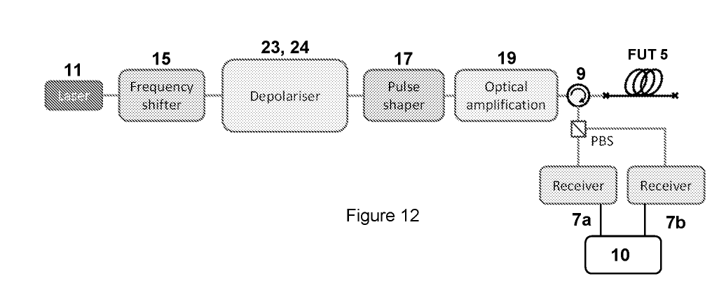

In another alternative embodiment of the present invention, any one of the above described systems is used to launch light (either polarised or depolarised) and to measure simultaneously the backscattered traces at, for example, two orthogonal polarizations using a polarization beam splitter or any other optical element or means to separate orthogonal polarization components of the backscattered field or signal in the receiver stage. An exemplary system is shown in FIG. 12.

The optical pulse inserted into the fibre 5 can comprise polarised light. For example, the polarization of the optical pulses launched into the fibre 5 can be aligned at 45° with respect to the polarization axes of a polarization-maintaining fibre. The frequency of the optical pulses provided to the fibre is varied as before.

Alternatively, the optical pulses inserted into the fibre 5 can comprise depolarised light and the frequency of the depolarised light optical pulses provided to the fibre is varied as before. The fibre 5 can be a fibre with low birefringence, such as a standard single-mode fibre, or a highly-birefringent fibre such as a polarization-maintaining fibre.

The polarization state of an optical pulse is determined as mentioned previously in any one of the previous embodiments. Similarly, depolarised light is obtained as mentioned previously in any one of the previous embodiments

By cross correlating (using computer 10) the spectra obtained at the two orthogonal channels (signals obtained at receivers 7a and 7b), the local phase birefringence of the fibre 5 is recovered from the spectral shift of the correlation peaks.

This embodiment is nevertheless less efficient than the previously described systems above.

### Experimental Demonstration of the Present Invention

### Validation Using the Basic Embodiment

### Experimental Setup:

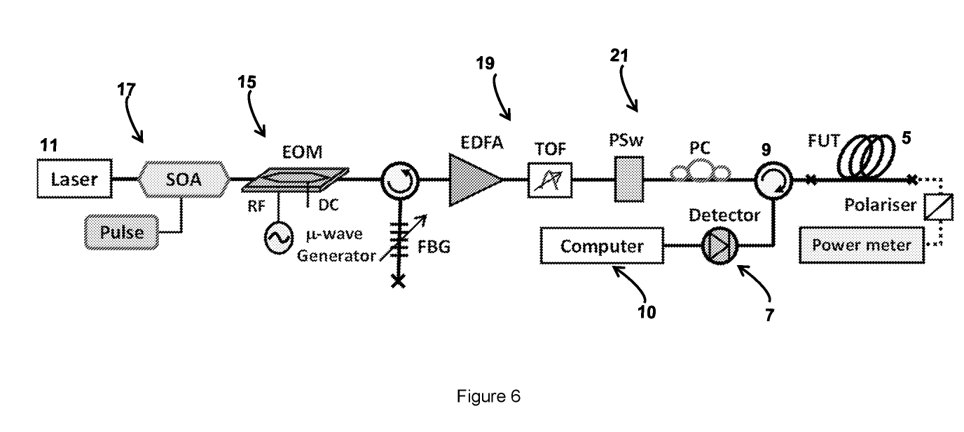

The exemplary experimental setup of the system 1 used to validate the invention is shown in FIG. 6. This implementation is essentially based on the first (basic) embodiment, described above and illustrated in FIG. 2.

The system 1 includes a distributed-feedback (DFB) laser operating at 1535 nm and a semiconductor optical amplifier (SOA) that are used to generate optical pulses with high extinction ratio (pulse shaper 17 is implemented by the semiconductor optical amplifier). The pulse width is set to 20 ns, corresponding to a spatial resolution of 2 m.

Whilst the laser temperature is tuned to coarsely scan the optical frequency of the pulses over a wide frequency range (many tens of GHz), an electro-optic modulator (EOM) driven by a microwave source is used to modulate the intensity of the light. This modulation process gives rise to two sidebands, symmetrically located around the frequency of the incoming light (i.e. around the emitted laser frequency). The spectral position of the sidebands can be accurately scanned with steps of 10 MHz by simply changing the frequency of the microwave source.

Considering that the light launched into the fibre 5 needs to have only a single frequency component (in the first embodiment), a tuneable filter (in this case a 10 GHz fibre Bragg grating—FBG) is utilised to select one of the sidebands generated by the EOM.

Frequency-shifted optical pulses are then amplified by an Erbium-doped fibre amplifier (EDFA), followed by a tuneable optical filter (TOF) used to suppress the amplified spontaneous emission (ASE) noise generated by the optical amplifier.

Before launching the pulses into the fibre 5 under test (FUT) using a circulator 9, a polarization switch (PSw) and a polarization controller (PC) are used to launch light into the FUT 5 with orthogonal states of polarization. Whilst the function of the polarization controller is to align the polarization of the pulses with one of the polarization axes of the fibre, the polarization switch changes the polarization of the light from a given state to, for example, the orthogonal one. Note that the polarization alignment carried out by the polarization controller is only necessary for optimisation when measuring high birefringence fibres, where the two orthogonal axes are clearly defined. This part of the scheme can be completely skipped when measuring low birefringence fibres such as SMFs, since a perfect alignment does not make sense in such fibres.

At the output of the FUT 5, a polariser and a power meter are used to ensure an optimised polarization alignment in the PMFs. These components are actually not essential for the invention, but they are helpful for optimising and monitoring the polarization alignment.

At the receiver 7, Rayleigh backscattered signals are directed into a 125 MHz bandwidth photo-detector, and the corresponding time-domain traces are acquired and processed by the computer 10.

### Experimental Results:

Using the setup depicted in FIG. 6, Rayleigh backscattered traces are measured for several distinct fibres: two PMFs (an 80 m Panda and a 100 m elliptical-core fibre) and one low birefringence fibre of 3 km-long.

First, measurements in PMFs are presented and discussed. In order to ensure an optimised polarization alignment to the slow and fast axes of the PMFs a well-defined procedure has been followed: this consists in adjusting the state of polarization of the light launched into the FUT 5, while the power at the fibre output is monitored. Thus, maximising (or minimising) the monitored power ensures a maximum coupling of light into the slow (or fast) polarization axis (in this case the polariser placed at the fibre output is aligned to the slow axis of the PMF). This way the correlation peak amplitude is enhanced, resulting in measurements with lower frequency uncertainty.

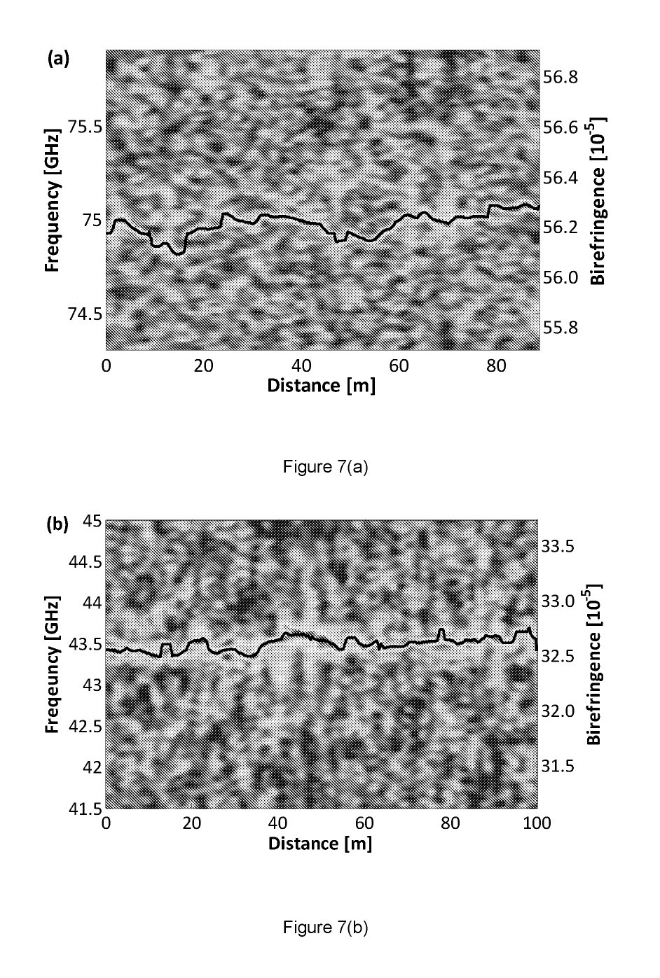

FIG. 7 shows the distributed profile of the birefringence-induced frequency shift (left vertical axis) as a function of distance, obtained from correlating Rayleigh spectral measurements at the two orthogonal states of polarization for the Panda (FIG. 7(a)) and elliptic-core (FIG. 7(b)) fibres.

Using the measured correlation frequency profile Δν(z), the distributed profile of the local phase birefringence Δn(z) has been obtained, as shown on the right vertical axis of the FIGS. 7(a) and 7(b). The depicted experimental results validate the proposed method of the present invention, which provides clear measurements of non-uniform phase birefringence along both optical fibres.

Then, the technique was used for birefringence measurements along a low birefringence fibre with a length of 3 km. The fibre corresponds to an old SMF drawn in the mid 1980's, when the core circularity was not well-controlled, unlike present-day fibres. Therefore non-uniform and larger birefringence values are expected in comparison to more recent SMFs. Since SMFs do not have clearly defined polarization axes, there is no polarization adjustment to perform in this case. However, measuring orthogonal states of polarization is still essential to ensure that no correlation fading impairs the measurements along the fibre.

Since SMFs are characterised by very small birefringence, the frequency accuracy of the measurements has to be tightly controlled. Although shifts in the correlation peak at zero frequency account for the average laser frequency drift within the measurement time (˜40s), a more robust and reliable system can be implemented if the laser frequency is locked into an absolute reference. Thus, in this case the laser frequency has been locked on a molecular absorption line of a gas cell, which is a hollow-core photonic crystal fibre filled with 5 mbars of acetylene gas in our particular implementation. A lock-in amplifier is used as a feedback system that provides injection current corrections to the laser driver, thus compensating the laser frequency drifts.

This way, the laser frequency variations have been reduced down to 300 kHz (or below) within the required measurement time, ensuring a negligible effect on the measured birefringence. Note that this frequency locking actually sets a limit to the frequency scanning range, restricted to the EOM bandwidth; however this is not a problem when measuring low birefringence fibres due to the small frequency shifts typically expected in this case. In this particular experiment, the time-domain traces have been obtained by simply scanning the microwave frequency driving the EOM over a range of 3 GHz.

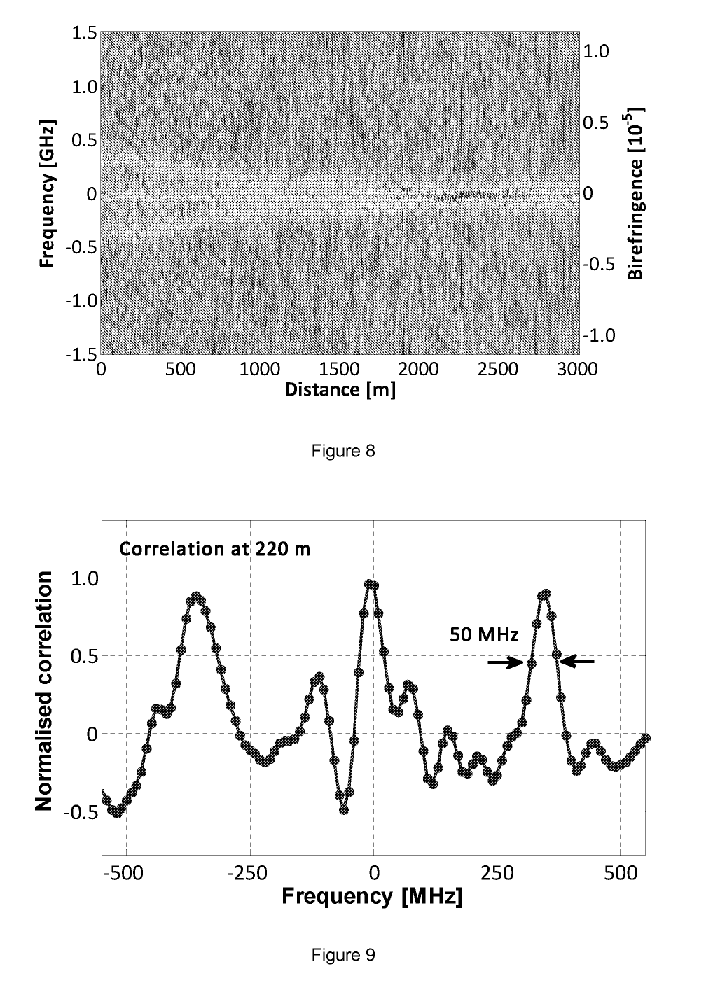

FIG. 8 shows the measured frequency shift (left-hand side vertical axis) and the respective birefringence profile (right-hand side vertical axis) along a 3 km-long SMF. The measurements are based on the embodiment and system of the present invention optimised for low birefringence fibres.

It is interesting to notice that clear variations of the local birefringence, being in the order of 10⁻⁶ can be precisely measured along the entire fibre length.

The best measurable birefringence is ultimately limited by the correlation peak width, which depends on the spectral width of the pulse. In this case the correlation peak with is 50 MHz, as shown in FIG. 9, being in agreement with the expected width defined by pulses of 20 ns. This corresponds to a minimum measurable birefringence of ˜3·10⁻⁷.

The spectral width of the correlation peak can be actually further reduced using longer spatial resolutions. However, in this case the laser linewidth also can impose some constraints to the minimum spectral width of the correlation peak. To partially overcome this, narrow linewidth lasers may be preferable.

### Validation Using the Embodiment Optimised for Low Birefringence Fibres

The experimental setup described in FIG. 6 has been modified in order to improve the accuracy of the measurements in low birefringence fibres.

The polarization switch and the polarization controller in front of the FUT 5 were removed; while an element as the one described in FIG. 4(b) has been inserted following the system configuration illustrated in FIG. 3.

Measurements of a low birefringence fibre are shown here using two different methods: calculating the cross-correlation of consecutive measurements based on the system of FIG. 2 described above, and calculating the auto-correlation of a single measurement using depolarised light based on the optimised system of FIG. 3.

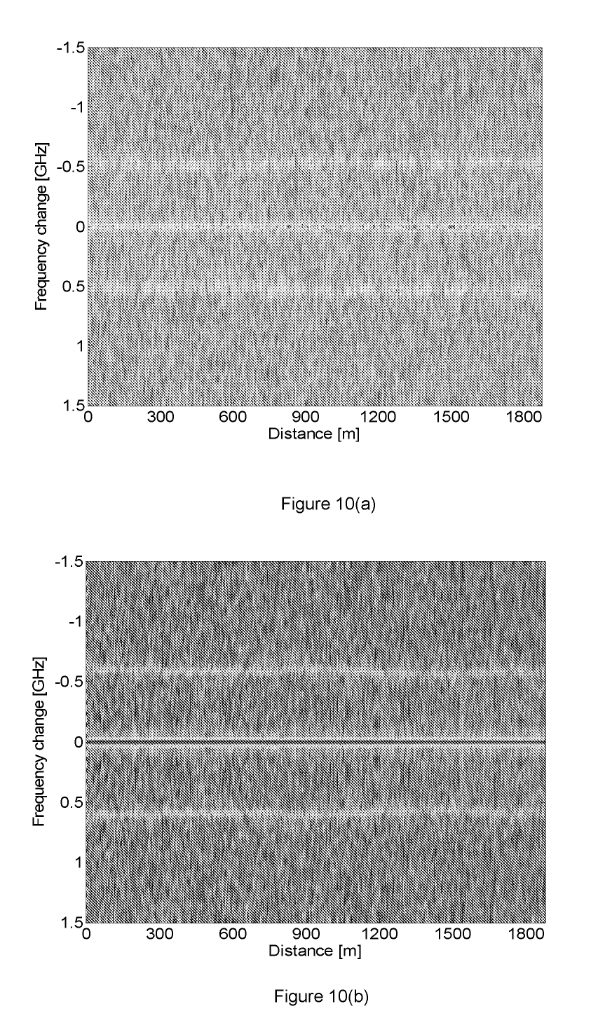

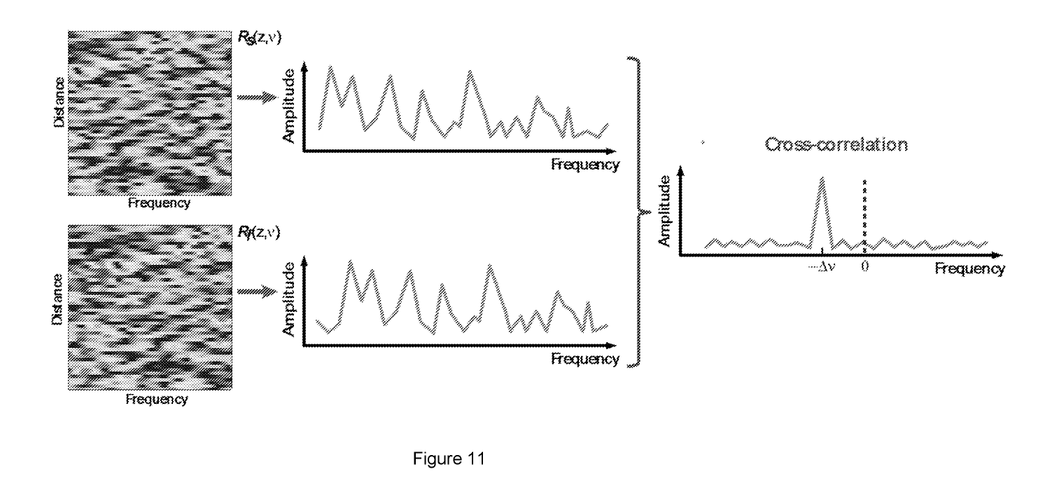

FIGS. 10(a) and 10(b) compare the spectrum obtained by the cross-correlation of consecutive measurements at orthogonal polarization in the basic system implementation of FIG. 2 (FIG. 10(a)) and the one obtained by auto-correlating a single measurement in the improved system configuration of FIG. 3 (FIG. 10(b)).

Whilst the basic system implementation of FIG. 2 shows a low signal-to-noise ratio (SNR) and clear intervals with fading response of the correlation peaks at ±Δν (FIG. 10(a)), the spectrum obtained launching into the fibre 5 the two orthogonal polarizations simultaneously (system of FIG. 3) shows an enhanced SNR and no section with correlation fading (FIG. 10(b)).

Having described now the preferred embodiments of this invention, it will be apparent to one of skill in the art that other embodiments incorporating its concept may be used. This invention should not be limited to the disclosed embodiments, but rather should be limited only by the scope of the appended claims.

### PUBLICATIONS

[1] B. Huttner, J. Reecht, N. Gisin, R. Passy, and J.-P. Von der Weid, “Local birefringence measurements in single-mode fibers with coherent optical frequency-domain reflectometry,” Photonics Technology Letters 10, 1458-1460 (1998).
[2] Y. Lu, X. Bao, L. Chen, S. Xie, and M. Pang, “Distributed birefringence measurement with beat period detection of homodyne Brillouin optical time-domain reflectometry,” Opt. Lett. 37, 3936-3938 (2012).
[3] Y. Dong, L. Chen, and X. Bao, “Truly distributed birefringence measurement of polarization-maintaining fibers based on transient Brillouin grating,” Opt. Lett. 35, 193-195 (2010).
[4] J. Juarez and H. Taylor, “Polarization discrimination in a phase-sensitive optical time-domain reflectometer intrusion-sensor system,” Opt. Lett. 30, 3284-3286 (2005).
[5] A. J. Rogers, “Polarization-optical time domain reflectometry: a technique for the measurement of field distributions,” Appl. Opt. 20(6), 1060-1074 (1981).
[6] J. N. Ross, “Birefringence measurement in optical fibers by polarization-optical time-domain reflectometry,” Appl. Opt. 21(19), 3489-3495 (1982).
[7] WO 2013185813 A1, Dec 19, 2013—A method and device for pressure sensing. Inventors: Sanghoon Chin and Etienne Rochat.
[8] WO 2009/099056 A2, Sep. 21, 2006—Calculation of birefringence in a waveguide based on Rayleigh scatter. Inventors: Mark E. Froggatt

[9] U.S. Pat. No. 7,330,245 B2, Feb. 12, 2008—Calculation of birefringence in a waveguide based on Rayleigh scatter. Inventors: Mark E. Froggatt

1-28. (canceled)

29. A system for determining an optical waveguide birefringence profile along a direction of light propagation of an optical waveguide, the system comprising:
a) an optical pulse generator for generating optical pulses to be injected into the optical waveguide;
b) a frequency adjustment device for modifying the optical frequency of the optical pulses to be injected into the optical waveguide;
c) a polarization control device configured to provide optical pulses with different polarization states for injection into the optical waveguide;
d) a receiver for acquiring a Rayleigh backscattered intensity signal as a function of time provided by optical pulses with different polarization states propagating through the optical waveguide; and
e) a processor configured to calculate a correlation value for a given location z₀ along the optical waveguide from the acquired Rayleigh backscattered intensity signal provided by optical pulses with different polarization states propagating through the optical waveguide.

30. The system according to claim 29, wherein the frequency adjustment device is configured to modify and set the optical frequency of the optical pulses to a predetermined optical frequency and to scan the frequency of the optical pulses through a predetermined optical frequency range.

31. The system according to claim 29, wherein the processor is configured to calculate a correlation value for a given location z₀ along the optical waveguide from the acquired Rayleigh backscattered intensity signal provided by optical pulses with different optical frequencies and with different polarization states propagating through the optical waveguide.

32. The system according to claim 29, wherein the processor is configured to calculate a cross-correlation value for the acquired Rayleigh backscattered intensity signals according to the equation Xcorr (z₀, Δν)=Rₓ (z₀, Δν)*R_{y} (z₀, ν) for a given location z₀ along the optical waveguide, to determine a spectral peak at an optical frequency shift Δν=ν_{y}−ννₓ proportional to an optical waveguide birefringence profile value (Δn=nₓ−n_{y}), where νₓ, ν_{y} are the optical frequencies of the optical pulse at a first polarization state and a second polarization state respectively, the first and second polarization states being different polarization states; and nₓ, n_{y} are refractive indexes values at the first and second polarization states.

33. The system according to claim 29, wherein the processor is configured to calculate a cross-correlation value for the acquired Rayleigh backscattered intensity signals according to the equation Xcorr (z₀, Δν)=Rₛ (z₀, ν)*R_{f} (z₀, ν) for a given location z₀ along the optical waveguide, to determine a spectral peak at an optical frequency shift Δν=ν_{f}−νₛ proportional to an optical waveguide birefringence profile value (Δn=nₛ−n_{f}), where νₛ, ν_{f} are the optical frequencies of the optical pulse at a first polarization state and a second polarization state respectively, the first and second polarization states being two substantially orthogonal polarization states; and nₛ, n_{f} are refractive indexes values at the two substantially orthogonal polarization axes.

34. The system according to claim 32, wherein the processor is configured to calculate the correlation between at least two Rayleigh backscattered intensity signals obtained while sweeping the optical frequency of the optical pulses through an optical frequency range, and configured to provide a resonance or correlation peak at a frequency detuning that is proportional to the refractive index difference between the first and second polarization states.

35. The system according to claim 29, further comprising:
a depolarizer configured to generate a single-frequency optical signal with a random state of polarization that is used to generate an optical pulse having a single optical frequency for injection into the optical waveguide.

36. The system according to claim 35, wherein the depolarizer includes an unbalanced Mach-Zehnder interferometer.

37. The system according to claim 35, wherein the depolarizer includes a polarization maintaining mirror and a Faraday mirror to generate at least two optical pulses having substantially orthogonal polarization states.

38. The system according to claim 35, wherein the depolarizer includes a polarization scrambler.

39. The system according to claim 29, further comprising:
a depolarizer including a differential group delay element, an unbalanced Mach-Zehnder interferometer, or a polarization maintaining mirror and a Faraday mirror to generate a depolarized pulse composed of two optical pulses having substantially orthogonal polarization states.

40. The system according to claim 39, wherein the frequency adjustment device is configured to provide an optical signal having at least two different optical frequencies, and the depolarizer is configured to rotate the polarization state of one of the frequency components with respect to the other frequency component of the optical signal to provide depolarized light to be shaped by a pulse shaper into a depolarized optical pulse for injection into the optical waveguide.

41. The system according to claim 32, wherein the processor is configured to calculate an auto-correlation spectrum from the acquired Rayleigh backscattered intensity signal including a superposition of Rayleigh backscattered intensity signals produced by the pulses of first and second polarization states to determine the birefringence profile along the optical waveguide.

42. The system according to claim 29, wherein the polarization control device includes a controller for aligning a polarization state of an optical pulse with a polarization axis of the optical waveguide.

43. A method for determining an optical waveguide birefringence profile along a direction of light propagation of an optical waveguide, the method comprising the steps of:
providing depolarized optical pulses of different optical frequencies, or optical pulses of different optical frequencies and of a different polarization state chosen between a first and second polarization state;
injecting the optical pulses into the optical waveguide;
acquiring a Rayleigh backscattered intensity signal as a function of time provided by the optical pulses propagating through the optical waveguide; and
calculating a correlation value for a given location z0 along the optical waveguide from the acquired Rayleigh backscattered intensity signal provided by the optical pulses propagating through the optical waveguide.

44. The method according to claim 43, further comprising the steps of:
a) providing an optical pulse having an optical frequency at an initial optical frequency value and the first polarization state and injecting the pulse into the optical waveguide;
b) acquiring a Rayleigh backscattered intensity signal as a function of time provided by the optical pulse propagating through the optical waveguide;
c) providing a further optical pulse having a different optical frequency at the first polarization state and injecting the further optical pulse into the optical waveguide;
d) acquiring the Rayleigh backscattered intensity signal as a function of time provided by the further optical pulse propagating through the optical waveguide;
e) repeating the above steps c) and d) of providing a further optical pulse of a different optical frequency and acquiring the Rayleigh backscattered intensity signal as a function of time until the frequency of the optical pulses has been modified and scanned through a predetermined optical frequency range;
f) providing an optical pulse having an optical frequency at an initial optical frequency value and the second polarization state and injecting the pulse into the optical waveguide;
g) acquiring a Rayleigh backscattered intensity signal as a function of time provided by the optical pulse propagating through the optical waveguide;
h) providing a further optical pulse having a different optical frequency at the second polarization state and injecting the optical pulse into the optical waveguide;
i) acquiring the Rayleigh backscattered intensity signal as a function of time provided by the further optical pulse propagating through the optical waveguide;
j) repeating the above steps h) and i) of providing a further optical pulse of a different optical frequency and acquiring the Rayleigh backscattered intensity signal as a function of time until the frequency of the optical pulses has been scanned through a predetermined optical frequency range; and
k) calculating a correlation value for a given location z₀ along the optical waveguide from the acquired Rayleigh backscattered intensity signal provided by optical pulses with different polarization states propagating through the optical waveguide.

45. The method according to claim 43, further comprising the steps of:
a) providing a first optical pulse having an optical frequency at an initial optical frequency value and the first polarization state and injecting the pulse into the optical waveguide;
b) acquiring a Rayleigh backscattered intensity signal as a function of time provided by the optical pulse propagating through the optical waveguide;
c) providing a second optical pulse having substantially the same optical frequency as the first pulse and the second polarization state and injecting the second optical pulse into the optical waveguide;
d) acquiring the Rayleigh backscattered intensity signal as a function of time provided by the optical pulse propagating through the optical waveguide;
e) providing a further first optical pulse having an optical frequency different to the initial optical frequency value and the first polarization state and injecting the pulse into the optical waveguide;
f) acquiring a Rayleigh backscattered intensity signal as a function of time provided by the optical pulse propagating through the optical waveguide;
g) providing a further second optical pulse having substantially the same optical frequency of the further first optical pulse and the second polarization state and injecting the further optical pulse into the optical waveguide;
h) acquiring the Rayleigh backscattered intensity signal as a function of time provided by the further second optical pulse propagating through the optical waveguide;
i) repeating the above steps e) to h) until the frequency of the further first and second optical pulses has been modified and scanned through a predetermined optical frequency range; and
j) calculating a correlation value for a given location z₀ along the optical waveguide from the acquired Rayleigh backscattered intensity signal provided by optical pulses with different polarization states propagating through the optical waveguide.

46. The method according to claim 43, wherein a cross-correlation value for the acquired Rayleigh backscattered intensity signals is calculated according to the equation Xcorr (z₀, Δν)=Rₓ (z₀, ν)*R_{y} (z₀, ν) for a given location z₀ along the optical waveguide, to determine a spectral peak at an optical frequency shift Δν=ν_{y}−νₓ proportional to an optical waveguide birefringence profile value (Δn=nₓ−n_{y}), where νₓ, ν_{y} are the optical frequencies of the optical pulse at the first polarization state and the second polarization state respectively, the first and second polarization states being different polarization states; and nₓ, n_{y} are refractive indexes values at the first and second polarization states.

47. The method according to claim 43, wherein a cross-correlation value for the acquired Rayleigh backscattered intensity signals is calculated according to the equation Xcorr (z₀, Δν)=Rₛ (z₀, ν)*R_{f} (z₀, ν) for a given location z₀ along the optical waveguide, to determine a spectral peak at an optical frequency shift Δν=ν_{f}-νₛ proportional to an optical waveguide birefringence profile value (Δn=nₛ-n_{f}), where νₛ, ν_{f} are the optical frequencies of the optical pulse at a first polarization state and a second polarization state respectively, the first and second polarization states being two substantially orthogonal polarization states; and nₛ, n_{f} are refractive indexes values at the two substantially orthogonal polarization axes.

48. The method according to claim 43, wherein the correlation value is calculated between at least two Rayleigh backscattered intensity signals obtained while sweeping the optical frequency of the optical pulses through an optical frequency range to provide a resonance or correlation peak at a frequency detuning that is proportional to the refractive index difference between the first and second polarization states.

49. The method according to claim 43, further comprising the steps of:
a) providing a depolarized optical pulse having an optical frequency at an initial optical frequency value and injecting the pulse into the optical waveguide;
b) acquiring a Rayleigh backscattered intensity signal as a function of time provided by the depolarized optical pulse propagating through the optical waveguide;
c) providing a further depolarized optical pulse having a different optical frequency and injecting the further depolarized optical pulse into the optical waveguide;
d) acquiring the Rayleigh backscattered intensity signal as a function of time provided by the further depolarized optical pulse propagating through the optical waveguide;
e) repeating the above steps c) and d) of providing a further depolarized optical pulse of a different optical frequency and acquiring the Rayleigh backscattered intensity signal as a function of time until the frequency of the further depolarized optical pulses has been modified and scanned through a predetermined optical frequency range; and
f) calculating a correlation value for a given location z₀ along the optical waveguide from the acquired Rayleigh backscattered intensity signal provided by depolarized optical pulses with propagating through the optical waveguide

50. The method according to claim 43, further comprising the steps of:
a) providing a first optical pulse having an optical frequency at an initial optical frequency value and the first polarization state, and providing a second optical pulse having an optical frequency at the initial optical frequency value and the second polarization state;
b) injecting the first optical pulse and the second optical pulse substantially simultaneously into the optical waveguide;
c) acquiring a Rayleigh backscattered intensity signal as a function of time provided by the optical pulses propagating through the optical waveguide;
d) providing a further first optical pulse having a different optical frequency and the first polarization state, as well as a further second optical pulse having an optical frequency at said different optical frequency and the second polarization state;
e) injecting the further first optical pulse and the further second optical pulse substantially simultaneously into the optical waveguide;
f) acquiring the Rayleigh backscattered intensity signal as a function of time provided by the optical pulses propagating through the optical waveguide;
g) repeating the above steps d), e) and f) of providing a further first optical pulse of a different optical frequency at the first polarization state and a further second optical pulse having an optical frequency at said different optical frequency and the second polarization state, injecting the further first optical pulse and the further second optical pulse substantially simultaneously into the optical waveguide, and acquiring the Rayleigh backscattered intensity signal as a function of time, until the frequency of the further first and second optical pulses has been modified and scanned through a predetermined optical frequency range; and
h) calculating a correlation value for a given location z₀ along the optical waveguide from the acquired Rayleigh backscattered intensity signal provided by optical pulses with different polarization states propagating through the optical waveguide.

51. The method according to claim 43, further comprising the steps of:
a) providing a first optical pulse having an optical frequency at a first optical frequency value and a first polarization state, and a second optical pulse having an optical frequency at a second optical frequency value and a second polarization state, the first and second optical frequencies being different in value;
b) injecting the first optical pulse and the second optical pulse substantially simultaneously into the optical waveguide;
c) acquiring a Rayleigh backscattered intensity signal as a function of time provided by the optical pulses propagating through the optical waveguide;
d) providing a further first optical pulse having a different optical frequency to the first optical frequency and the first polarization state, as well as a further second optical pulse having a different optical frequency to the second optical frequency and the second polarization state;
e) injecting the further first optical pulse and the further second optical pulse substantially simultaneously into the optical waveguide;
f) acquiring the Rayleigh backscattered intensity signal as a function of time provided by the optical pulses propagating through the optical waveguide;
g) repeating the above steps d), e) and f) of providing a further first optical pulse of a different optical frequency and the first polarization state, as well as a further second optical pulse having a different optical frequency to the second optical frequency and the second polarization state, injecting the further first optical pulse and the further second optical pulse substantially simultaneously into the optical waveguide, and acquiring the Rayleigh backscattered intensity signal as a function of time, until the frequency of the first and second optical pulses has been modified and scanned through a predetermined optical frequency range; and
h) calculating a correlation value for a given location z₀ along the optical waveguide from the acquired Rayleigh backscattered intensity signal provided by optical pulses with different polarization states propagating through the optical waveguide.

52. The method according to claim 49, wherein an auto-correlation spectrum is calculated from the acquired Rayleigh backscattered intensity signal including a superposition of Rayleigh backscattered intensity signals produced by the depolarized optical pulses or the pulses of first and second polarization states to determine the birefringence profile along the optical waveguide.

53. The method according to claim 43, further including a step of aligning a polarization state of an optical pulse with a polarization axis of the optical waveguide.

54. The method according to claim 43, wherein the different polarization states or the first and second polarization states are substantially orthogonal polarization states.

55. A sensor including the system of claim 29.
